(19) United States
(12) Patent Application Publication
(10) Pub. No.: US 2015/0159585 A1
(43) Pub. Date: Jun. 11, 2015

(54) SYSTEM AND METHOD FOR REPAIR OF CAST COMPONENT

(71) Applicant: Caterpillar Inc., Peoria, IL (US)

(72) Inventors: Christopher A. Kinney, Iuka, MS (US); Benjamin J. Rasmussen, Corinth, MS (US); Kegan J. Luick, Corinth, MS (US); Trent A. Simpson, Peoria, IL (US); Bradley Rice, Corinth, MS (US); Thomas Parnell, Iuka, MS (US); Curtis J. Graham, Peoria, IL (US)

(73) Assignee: Caterpillar Inc., Peoria, IL (US)

(21) Appl. No.: 14/098,669

(22) Filed: Dec. 6, 2013

(51) Int. Cl. F02F 7/00; B23P 6/04

(52) U.S. Cl. CPC F02F 7/0002; B23P 6/04

(57) ABSTRACT

A method for repairing a cast component having a damaged area is provided. The method includes scanning an area adjacent to the damaged area to create a scan. The method includes forming a dam with a void. The void has a profile corresponding to the scan. The method includes positioning the dam adjacent to the damaged area. The method includes heating the cast component. The method includes introducing a repair material into the dam. The method also includes cooling the cast component. The method further includes removing an excess material from the cast component.

### TECHNICAL FIELD

The present disclosure relates to a system and method for repair of a damaged component, and more specifically to the system and method for repairing a damaged cast component.

### BACKGROUND

Damaged cast components having a variable and/or complex profile, for example, an engine block, may be repaired by replacing a damaged area of the cast component with a donor material having a profile matching to that of the damaged area. In some situations, the donor material is welded to the damaged area by known welding processes such as, Metal Inert Gas (MIG) welding, oxy-fuel welding to fill a gap between the donor material and the damaged area and so on. Welding may need to be done multiple times in sequential layers until the gap is completely filled by the weld. Further, the weld may have defects which may require removal and cleaning of the welded area and may require subsequent re-welding in order to achieve required quality of the repaired damaged area. Further, the welded sections of the repaired damaged area may require to be machined after completion of the welding process to match the profile of the cast component.

Alternatively, a common mold may also be used having a profile matching the profile of the damaged area. A molten filler material is then introduced into the mold and fused with the damaged area for repairing the damage. However, the profile of the common mold may sometimes be inaccurate and may not match the profile of the damaged area. This may lead to leakage of the molten filler material. Such leaks may lead to material wastage and also unsatisfactory quality of the repaired damaged area.

Hence, there is a need for an improved method for repairing the damaged cast component.

U.S. Pat. No. 7,047,612 discloses a method for repairing a casting, and more specifically to a method of repairing a casting by pouring melted filler material into a damaged portion of the original casting. Damaged cast metal components, such as a cylinder head of an internal combustion engine are repaired by preheating the component to a first preheat temperature. The damaged area of the casting is then heated to a higher temperature using a torch and melted filler material is poured into the casting. The torch is used to maintain the temperature of the melted material for thirty seconds to two minutes. The temperature of the filler material is then cooled using compressed air.

### SUMMARY OF THE DISCLOSURE

In one aspect of the present disclosure, a method for repairing a cast component having a damaged area is provided. The method includes scanning an area encompassing the damaged area present on the cast component to create a scan of the damaged area and/or the adjacent area. The method includes forming a dam with a void. The void has a profile corresponding to the scan. The method includes positioning the dam adjacent to the damaged area. The method includes heating the cast component. The method includes introducing a repair material into the dam. The method also includes cooling the cast component. The method further includes removing an excess material from the cast component.

In another aspect of the present disclosure, an engine block is provided. The engine block includes a main body casting. The engine block also includes a repaired portion integrated with the main body. The repaired portion is made of a repair material. The repair material is introduced into a dam positioned adjacent to a damaged area of the main body. The dam is formed to include a void. The void has a profile which matches a scan. The scan is created by scanning an area encompassing the damaged area.

In yet another aspect of the present disclosure, a cast component repaired by a process is provided. The process includes scanning an area encompassing a damaged area present on the cast component to create a scan. The process includes forming a dam with a void. The void has a profile corresponding to the scan. The process includes positioning the dam adjacent to the damaged area. The process includes heating the cast component. The process includes introducing a repair material into the dam. The process also includes cooling the cast component. The process further includes removing an excess material from the cast component.

Other features and aspects of this disclosure will be apparent from the following description and the accompanying drawings.

### BRIEF DESCRIPTION OF THE DRAWINGS

FIG. 1 is a perspective view of an exemplary engine block, according to one embodiment of the present disclosure;

FIG. 2 is a perspective view of a portion of the engine block of FIG. 1 having a damaged area thereon;

FIG. 3 is a perspective view of the portion of the engine block of FIG. 2 having a dam affixed to the damaged area;

FIG. 4 is a perspective view of the portion of the engine block after repair; and

FIG. 5 is a flowchart of a method for repairing a cast component.

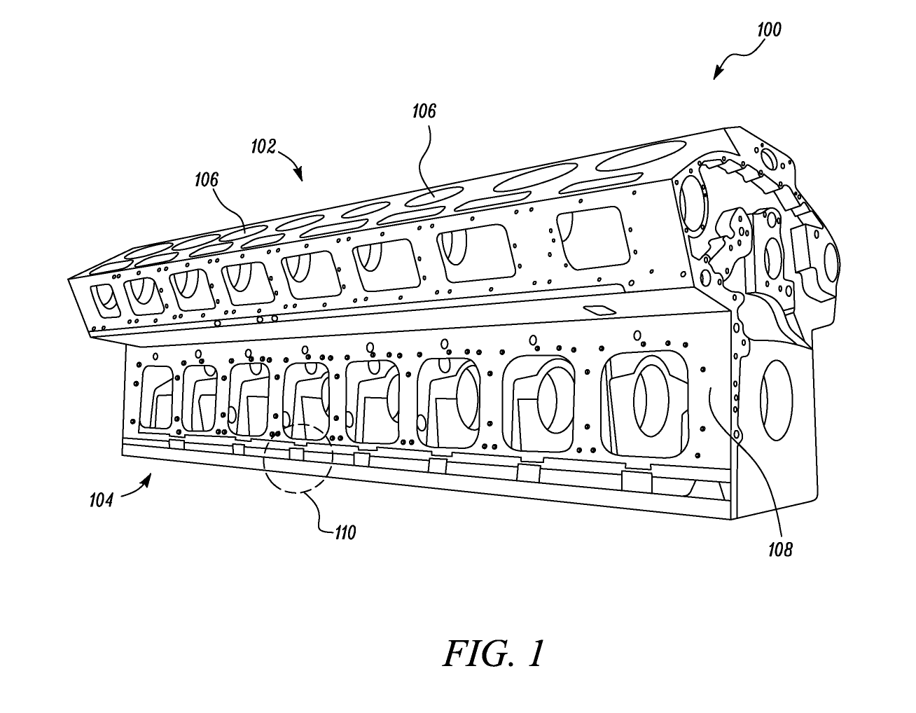

### DETAILED DESCRIPTION

Wherever possible, the same reference numbers will be used throughout the drawings to refer to the same or the like parts. Referring to FIG. 1, an exemplary engine block 100 is illustrated, according to one embodiment of the present disclosure. More specifically, the engine block 100 illustrated is of a V-configuration engine. It should be noted, that the configuration of the engine block 100 disclosed herein is merely exemplary and may vary as per system design and requirements. For example, the configuration of the engine block 100 may include an inline configuration engine or a horizontally opposed configuration engine.

The engine block 100 includes a cylinder end 102 and a crankshaft end 104. The cylinder end 102 of the engine block 100 includes one or more cylinders 106. Each of the cylinders 106 is configured to receive and support a piston (not shown) of a piston-connecting rod assembly. The crankshaft end 104 of the engine block 100 is configured to receive and support a crankshaft (not shown) of an engine.

The engine block 100 includes a main body casting 108. The main body casting 108 may be generally formed as a single component. The main body casting 108 may be formed by any casting process known in the art including, but not limited to, centrifugal casting, investment casting, high pressure die casting, and permanent mold casting. The main body casting 108 may be made of any metal or an alloy including, but not limited to, gray cast iron, ductile iron, compacted graphite iron, steel, and aluminum.

During operation of the engine, the engine block 100 may be subjected to excessive stress due to extreme working pressure and temperature. In such a situation, the main body casting 108 may undergo failures such as, fatigue failures and so on, at various locations resulting in structural damage to the main body casting 108. In some situations, during operation of the engine, one or more working components housed within or proximate to the engine block 100 may undergo structural failure and may disintegrate. Such disintegrated sections of a failed component may strike against a portion of the main body casting 108 and cause damage to the engine block 100.

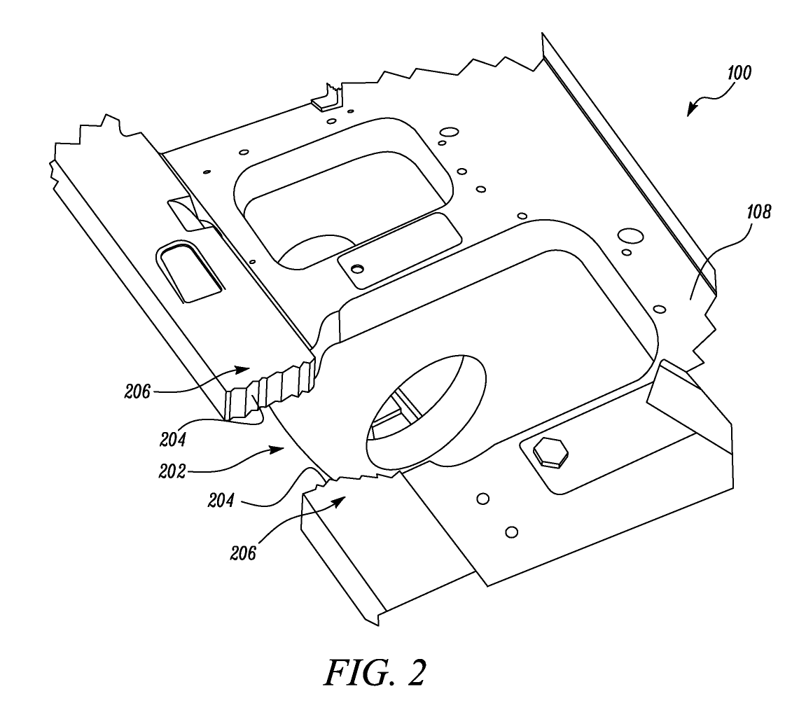

In the illustrated embodiment, as shown in FIG. 1, an encircled portion 110 is an exemplary portion of the main body casting 108 that undergoes a structural damage. This structural damage may take place in a situation when the adjacent connecting rod may fail and strike against the encircled portion 110 of the main body casting 108 during operation of the engine. Referring to FIG. 2, due to a striking force generated as the failed connecting rod may strike against the main body casting 108, the portion of the main body casting 108 may shear off and create a damaged area 202 on the main body casting 108. This damaged area 202 may have to be repaired and/or refurbished before the engine block 100 may be put into further operational use.

A system and method is disclosed herein for repairing the damaged area 202 of the main body casting 108. Initially, one or more edges 204 of the damaged area 202 may be cleaned to smoothen out excessive depressions, irregularities and/or roughness that may be formed due to the shearing of the portion of the main body casting 108. The cleaning of the edges 204 may be performed by any known machining process such as, for example, grinding. The machining of the edges 204 may provide evenness of the edges 204 for performing the repair process.

After the machining of the edges 204, an area 206 encompassing the damaged area of 202 and the edges 204 is scanned to create a scan of the damaged area 202 between the edges 204. More specifically, the scan may be created by scanning the edges 204 and/or areas around the edges 204. The scanning may be performed by any scanning methods known in the art including, but not limited to, mechanical scanning or probing technique, optical scanning technique, laser scanning technique and ultrasonic scanning technique. Based on the scanning process, the scan matching a profile of the damaged area 202 is created.

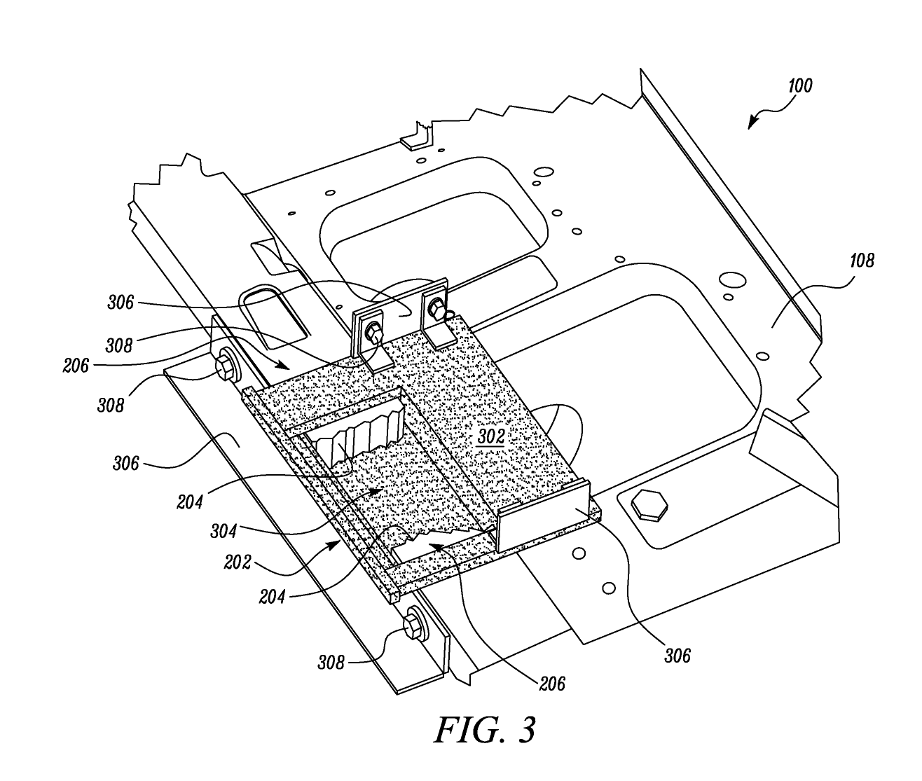

As shown in FIG. 3, a dam 302 is formed having a profile matching the scan of the damaged area 202, the adjacent area 206 and a profile of a desired repaired area. The profile of the desired repaired area may correspond to the scan of the damaged area 202 and/or the adjacent area 206. The dam 302 may be configured as a mold having a void 304 therein. A profile of the void 304 may correspond to the scan of the damaged area 202 and/or the adjacent area 206. Further, the profile of the void 304 may have larger dimensions with respect to dimensions of the desired repaired area. In such a situation, an excess material that may have deposited due to the larger dimensions of the profile of the void 304 may be machined to obtain the dimensions of the desired repaired area.

In one example, the dam 302 may be formed by reverse engineering the scan of the damaged area 202, and the adjacent area 206, using a method known to one skilled in the art. Creation of the dam 302 by reverse engineering the scan may allow for achieving accurate dimensions of the dam 302 and thus having relatively low or close to zero tolerance between the profile of the dam 302 and the profile of the damaged area 202 of the main body casting 108.

The dam 302 may be formed as a single component or a multi piece component. In the embodiment illustrated in FIG. 3, the dam 302 is formed as the multi piece component. The dam 302 is positioned adjacent to the damaged area 202 surrounding the edges 204. More specifically, the dam 302 may be positioned around the damaged area 202 in a manner such that the void 304 may be placed between the edges 204 of the damaged area 202. The dam 302 may be removably affixed onto the main body casting 108 by using one or more support means 306 and/or fastening means 308. The support means 306 may include, but not limited to, bars, channels, plates, rods, and angles in order to accurately orient the dam 302 around the damaged area 202. The fastening means 308 may include, for example, bolts, screws, clamps, welds and so on to rigidly affix the dam 302 around the damaged area 202.

The dam 302 may be formed of any material known in the art used for casting and/or molding purposes. For example, in one embodiment, the dam 302 may be formed of ceramic, sand and/or any other non-metallic material. In another embodiment, the dam 302 may be formed of a repair material and may be made of any metal known in the art. For example, the dam 302 may be made of a metal same as that of a metal of the main body casting 108. In such an embodiment, the dam 302 may be consumed in the repair process and will be explained in detail subsequently.

After positioning the dam 302 around the damaged area 202, the main body casting 108 may be heated to a first predetermined temperature. The first predetermined temperature is lower than a melting point of the metal of the main body casting 108. The main body casting 108 may be heated to the first predetermined temperature in order to prevent excessive metallurgical changes in the main body casting 108 pre and/or post the repair process. Further, the main body casting 108 may be locally heated at and around the damaged area 202 to a second predetermined temperature. The second predetermined temperature is higher than the first predetermined temperature and lower than the melting point of the metal of the main body casting 108. The main body casting 108 may be heated to the second predetermined temperature for efficient fusing of the damaged area 202 with the repair material.

After heating the main body casting 108 and locally heating the damaged area 202 as explained above, the repair material is introduced in the void 304 of the dam 302. In one embodiment, the repair material may be a molten metal which may be poured into the void 304 of the dam 302. In another embodiment, the repair material may be a combination of a solid metal and the molten metal. In such a situation, a donor repair material in the solid form may be provided inside the void 304 of the dam 302 and in between the edges 204 of the damaged area 202 such that gaps may be present between the donor material and the damaged area 202. Further, in this situation, the molten metal may be introduced into the void 304 such that the molten metal may fill in the gaps between the donor material, the edges 204 of the damaged area 202 and/or the surfaces of the dam 302. The molten metal may be same or different from the metal used to form the main body casting 108.

As the molten metal is poured into the void 304, due to heat transfer between the molten metal and the heated damaged area 202, the temperature of the damaged area 202 may further rise allowing for fusing of the edges 204 of the damaged area 202 with the molten metal. In a situation wherein the dam 302 is to be consumed, the dam 302 may also be heated up to the second predetermined temperature. Further, after introduction of the molten metal into the dam 302, the dam 302 may fuse with the repair material and thereby be consumed into the damaged area 202. The main body casting 108 is then allowed to cool so that the repair material and the dam 302 may integrate with the main body casting 108 for repairing the damaged area 202.

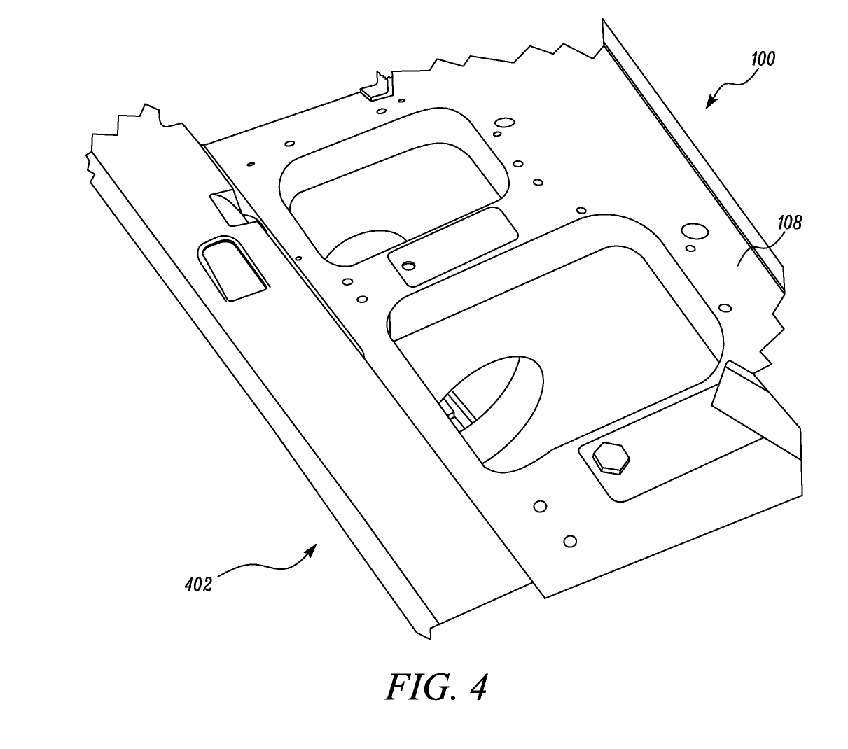

Alternatively, in another scenario, as shown in FIG. 4, the dam 302 may be removed after the repair material and the damaged area 202 are cooled to complete the fusing process. The fusing process results in the formation of a repaired area 402 matching that of the damaged area 202. For example, the dam 302 may be removed by loosening and removing the support means 306 and/or the fastening means 308.

Further, after removal of the support means 306, the fastening means 308 and/or the dam 302, the excess material that may have fused with the repaired area 402 or any other portion of the main body casting 108 during the repair may be removed by known machining processes, such as, for example, grinding. This excess material may be at least a portion of the repair material, and/or a portion of the dam 302 when the dam 302 is consumed into the repaired area 402. The machining may be required for matching the profile of the repaired area 402 with the main body casting 108.

### INDUSTRIAL APPLICABILITY

A method for the repair of the damaged area 202 on the main body casting 108 of the engine block 100 is disclosed herein. By utilizing the scan of the damaged area 202 and the adjacent area 206 to form the dam 302, the profile of the dam 302 may be relatively accurate to that of the damaged area 202. As a result, leakage of the repair material or accumulation of the excess material external to that of the damaged area 202 may be prevented. This in turn may reduce the machining or grinding required for the finishing of the repaired main body casting 108. In situations in which the dam 302 is consumed into the repaired area 402, wastage of the dam 302 itself may be prevented.

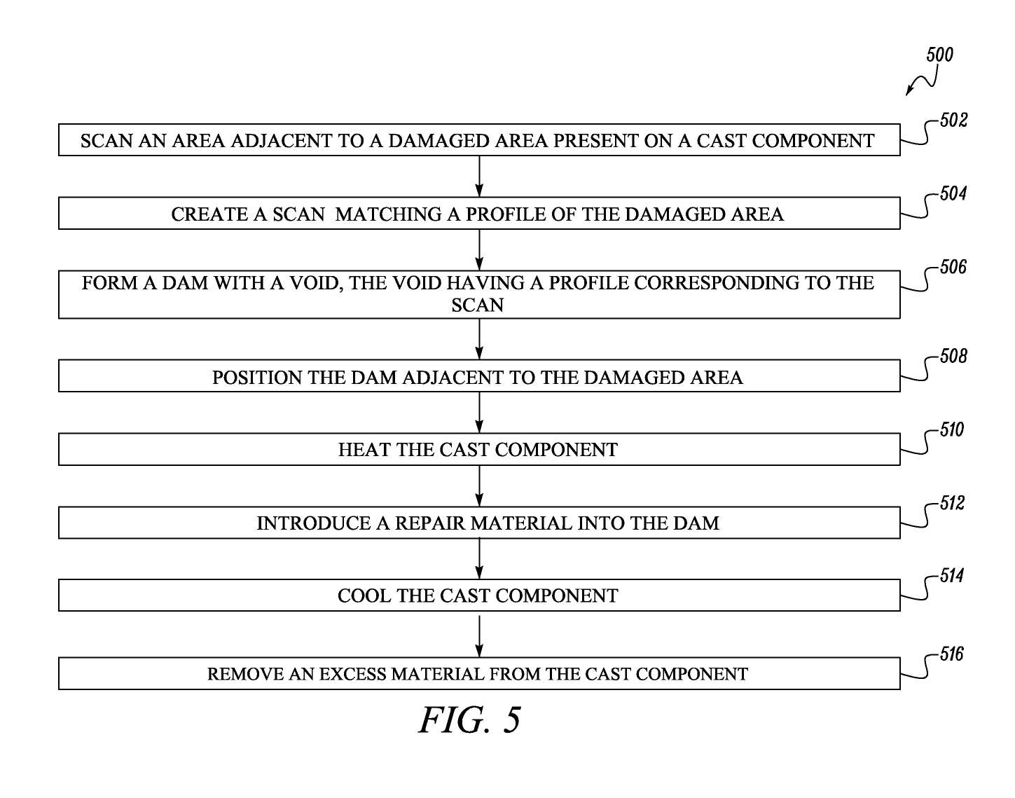

Referring to FIG. 5, a flowchart illustrates a method 500 for repairing the damaged area 202 of the main body casting 108. At step 502, the damaged area 202 present on the main body casting 108 is scanned by using any known scanning technique such as mechanical scanning or probing technique, optical scanning technique, laser scanning technique, ultrasonic scanning technique and so on. At step 504, the scan of the damaged area 202 is created such that the scan matches the profile of the damaged area 202. At step 506, the dam 302 is formed with the void 304 such that the profile of the dam 302 and/or the void 304 corresponds to the scan.

At step 508, the dam 302 is positioned adjacent to the damaged area 202. The dam 302 may be affixed to the main body casting 108 using the support means 306 and the fastening means 308. At step 510, the main body casting 108 is heated to raise the temperature of the main body casting 108 to a first predetermined temperature. The first predetermined temperature is lower than the melting point of the metal of the main body casting 108. Further, the temperature of the damaged area 202 and/or the dam 302 is locally raised to a second predetermined temperature. The second predetermined temperature is higher than the first predetermined temperature.

At step 512, the repair material is introduced in the void 304 of the dam 302. The repair material may be the molten metal or a combination of the solid metal and the molten metal. At step 514, the repair material is allowed to cool. The repair material may be allowed to cool naturally or may be force cooled by using blowers, fans, compressed air and so on. During the cooling, the repair material fuses with the dam 302 and/or the damaged area 202 to form the repaired area 402. At step 516, the excess material is removed from the main body casting 108 by any known machining process, such as, grinding and so on. In one embodiment, the excess material may be the additional material that may have fused with the repaired area 402 during cooling. In another embodiment, the excess material may be the portion of the dam 302 when the dam 302 is formed of the same material as that of the repair material. A person of ordinary skill in the art will appreciate that although the above description is in relation to the damage of the engine block 100, the said method of repair may be utilized for the repair of any cast component without deviating from the scope of the present disclosure.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for repairing a cast component having a damaged area, the method comprising:
scanning an area encompassing the damaged area to create a scan;
forming a dam with a void, the void having a profile corresponding to the scan;
positioning the dam adjacent to the damaged area;
heating the cast component;
introducing a repair material into the dam;
cooling the cast component; and
removing an excess material from the cast component.

2. The method of claim 1, wherein the excess material includes at least one of a portion of the dam and a portion of the repair material.

3. The method of claim 1, wherein at least a portion of the repair material is in molten form.

4. The method of claim 1, wherein the heating step further includes:
raising a temperature of the cast component to a first predetermined temperature, the first predetermined temperature is lower than a melting point of a metal of the cast component; and
raising a temperature of the damaged area to a second predetermined temperature, the second predetermined temperature being higher than the first predetermined temperature.

5. The method of claim 1, wherein the heating step further includes heating the dam.

6. The method of claim 5 further comprising:
fusing the dam and the repair material therein with the cast component prior to the cooling.

7. The method of claim 1, wherein the positioning step further includes affixing, removably, the dam onto the cast component using mechanical fasteners.

8. The method of claim 1, wherein the removal step further includes machining the repair material to cooperate with the cast component.

9. The method of claim 1, wherein the area encompassing the damaged area is scanned using at least one of mechanical, optical and laser techniques.

10. An engine block comprising:
a main body casting; and
a repaired portion integrated with the main body, wherein the repaired portion is made of a repair material such that the repair material is introduced into a dam positioned adjacent to a damaged area of the main body, such that the dam is formed to include a void, the void having a profile which matches a scan, wherein the scan is created by scanning an area encompassing the damaged area.

11. The engine block of claim 10, wherein the dam is consumed into the repaired portion.

12. The engine block of claim 10, wherein the dam is made of a ceramic or a metal.

13. A cast component repaired by a process comprising the steps of:
scanning an area encompassing a damaged area to create a scan;
forming a dam with a void, the void having a profile corresponding to the scan;
positioning the dam adjacent to the damaged area;
heating the cast component;
introducing a repair material into the dam;
cooling the cast component; and
removing an excess material from the cast component.

14. The cast component of claim 13, wherein the excess material includes at least one of a portion of the dam and a portion of the repair material.

15. The cast component of claim 13, wherein at least a portion of the repair material is in molten form.

16. The cast component of claim 13, wherein the heating step further includes:
raising a temperature of the cast component to a first predetermined temperature, the first predetermined temperature is lower than a melting point of a metal of the cast component; and
raising a temperature of the damaged area to a second predetermined temperature, the second predetermined temperature being higher than the first predetermined temperature.

17. The cast component of claim 13, wherein the heating step further includes heating the dam.

18. The cast component 17, wherein the process further comprises the step of:
fusing the dam and the repair material therein with the cast component prior to the cooling.

19. The cast component of claim 13, wherein the positioning step further includes affixing, removably, the dam onto the cast component using mechanical fasteners.

20. The cast component of claim 13, wherein the removal step further includes machining the repair material to cooperate with the cast component.
